(19) United States
(12) Patent Application Publication
(10) Pub. No.: US 2009/0064601 A1
(43) Pub. Date: Mar. 12, 2009

(54) STRUCTURAL MEMBER

(75) Inventor: Sander Kroes, New South Wales (AU)

Correspondence Address: BELL, BOYD & LLOYD, LLP, P.O. Box 1135, CHICAGO, IL, 60690, US

(73) Assignee: FIVE Y'S PTY LTD, Mount Ousley (AU)

(21) Appl. No.: 12/278,865

(22) PCT Filed: Feb. 8, 2007
(86) PCT No.: PCT/AU07/00130

§ 371 Date: Oct. 16, 2008

(30) Foreign Application Priority Data
Feb. 8, 2006 (AU) 2006900606

(51) Int. Cl. F16B 5/07

(52) U.S. Cl. 52/108

(57) ABSTRACT

A structural member includes a first meshing element having two prisms disposed in a side-by-side arrangement wherein a space between the prisms defines a first meshing element engagement cavity. Each prism in the first meshing element is connected to an adjacent prism via an arm of a hinge disposed intermediate the prisms. The structural member includes a second meshing element having two prisms disposed in a side-by-side arrangement where a space between the prisms defines a second meshing element engagement cavity. Each prism in the second meshing element is connected to an adjacent prism via an arm of a hinge disposed intermediate the prisms. A prism of the second meshing element is configured to be retained in a first meshing element engagement cavity and wherein a prism of the first meshing element is configured to be retained in a second meshing element engagement cavity such that the first and second meshing elements are movable into locking engagement and each meshing element extends substantially parallel to the other.

### FIELD OF THE INVENTION

The present invention relates to structural members and structural articles formed therefrom.

The invention has been developed primarily with reference to structural members in the form of walls, boards, partitions, platforms, panels, packaging and conveyor systems and will be described hereinafter with reference to these applications. However, it will be appreciated that the invention is not limited to these particular fields of use.

### BACKGROUND ART

Structural members come in a variety of forms for a variety of applications such as for use in constructions or in packaging, for example. In applications relating to construction, for example, floors or walkways, individual boards or large sheets are affixed to a frame which supports the weight of the boards or sheets and any load applied thereon. In some cases, boards can be joined along a marginal edge to adjacent boards in a tongue and groove arrangement.

If the boards or sheets are composed of a material which has insufficient inherent strength to bear a load applied to the walkway or floor, for example, undesirable deflections or breakage of the boards or sheets can occur under a load. In order to facilitate the possible loading of various weights, the boards or sheets are typically relatively heavy and are not collapsible or foldable making transport and other logistical aspects more constrained.

Furthermore, structural members used for construction are usually made to be fixed in a particular location so as to be ‘permanently’ disposed at a site. In such cases, the structural members are typically considered not to be of any use in other construction applications and are often initially planned to be scrapped at the end of their working life at a specific location.

In respect of packaging, a most ubiquitous device is a box formed from cardboard or other material and which can be made to collapse or fold allowing for these of transport. However, such boxes are typically rectilinear and are square or rectangular in cross-section. That is, contoured shape boxes are not in widespread use. It is known to provide boxes which fold but these are generic and specific box or packaging types that are made to receive a particular item, for example a crystal drinking glass, can collapse and fold to minimise storage and transport. However, often this packaging is not structurally sound so as to bear a relatively large load.

### OBJECT OF THE INVENTION

It is an object of the present invention to provide a structural member that can be relatively easily collapsed or folded and relatively easily transported and which ameliorates or one or more of the disadvantages of the prior art, or to provide a useful alternative.

### SUMMARY OF THE INVENTION

According to a first aspect of the present invention there is disclosed a structural member including:
a first meshing element having two prisms disposed in a side-by-side arrangement wherein a space between the prisms defines a first meshing element engagement cavity, each prism in the first meshing element being connected to an adjacent prism via an arm of a hinge disposed intermediate the prisms;
a second meshing element having two prisms disposed in a side-by-side arrangement wherein a space between the prisms defines a second meshing element engagement cavity, each prism in the second meshing element being connected to an adjacent prism via an arm of a hinge disposed intermediate the prisms;
wherein a prism of the second meshing element is configured to be retained in a first meshing element engagement cavity and wherein a prism of the first meshing element is configured to be retained in a second meshing element engagement cavity such that the first and second meshing elements are movable into locking engagement and each meshing element extends substantially parallel to the other.

According to a second aspect of the present invention there is disclosed a structural member including:
a first meshing element composed of at least one sheet of fibreboard, the first meshing element being folded to form at least two prisms disposed in a side-by-side arrangement wherein a space between the prisms defines a first meshing element engagement cavity, each prism in the first meshing element being connected to an adjacent prism by a fold;
a second meshing element composed of at least one sheet of fibreboard, the second meshing element being folded to form at least two prisms disposed in a side-by-side arrangement wherein a space between the prisms defines a second meshing element engagement cavity, each prism in the second meshing element being connected to an adjacent prism by a fold;
wherein a prism of the second meshing element is configured to be lockingly engaged in a first meshing element engagement cavity and wherein a prism of the first meshing element is configured to be retained in a second meshing element engagement cavity such that the first and second meshing elements are movable into locking engagement and each meshing elements extends substantially parallel to the other.

According to third aspect of the present invention there is disclosed a structural member formed from a plurality of components and including:
a first meshing element having two prisms disposed in a side-by-side arrangement wherein a space between the prisms defines a first meshing element engagement cavity, each prism in the first meshing element being connected to an adjacent prism via an arm of a hinge disposed intermediate the prisms; and
a second meshing element having two prisms each configured for engagement with at least one first meshing element engagement cavity;
wherein a prism of the second meshing element is configured to be retained in a first meshing element engagement cavity such that the first and second meshing elements are movable into locking engagement and each meshing element extends substantially parallel to the other.

According to another aspect of the present invention there is disclosed a structural member including:
a first meshing element having two prisms configured to be disposed in a side-by side arrangement wherein a space between the prisms defines a first meshing element engagement cavity, each prism having a prism body with a hinge arm extending a predetermined distance therefrom, each prism body having a hinge spaced apart from the hinge arm, each hinge aim configured for releasable engagement with an adjacent prism of the first meshing element; and
a second meshing element having two prisms configured to be disposed in a side-by-side arrangement wherein a space between the prisms defines a second meshing element engagement cavity, each prism having a prism body with a hinge arm extending a predetermined distance therefrom, each prism body having a hinge spaced apart from the hinge arm, each hinge arm configured for releasable engagement with an adjacent prism of the second meshing element;
wherein a prism of the second meshing element is configured to be retained in a first meshing element engagement cavity and wherein a prism of the first meshing element is configured to be retained in a second meshing element engagement cavity such that the first and second meshing elements are movable into locking engagement and each meshing element extends a substantially parallel to each other.

### BRIEF DESCRIPTION OF THE DRAWINGS

Preferred embodiments of the invention will now be described, by way of example only, with reference to the accompanying drawings in which:

FIG. 1 is an elevated perspective view of first and second meshing elements of a structural member according to a first preferred embodiment;

FIGS. 2 to 11 show the meshing elements of FIG. 1 being moved into locking engagement with each other to form a structural member;

FIGS. 12 to 21 show first and second meshing elements of another preferred embodiment being moved into locking engagement with each other to form a structural member;

FIGS. 22 to 26 are side views of a first meshing element and five different types of second meshing element according to further preferred embodiments and the bottom of each Fig. is a side view of each type of second meshing element when moved into locking engagement with the first meshing element;

FIG. 27 is a side view of a structural member in the form of a closed loop;

FIGS. 28 is an enlarged view of the locking of the ends of the first and second meshing elements forming the closed loop of FIG. 27;

FIGS. 29 to 32 are enlarged side views of other preferred embodiments of the locking of the ends of the first and second meshing elements forming a closed loop;

FIG. 33 shows a structural member according to another preferred embodiment;

FIG. 34 shows a structural member according to another preferred embodiment;

FIG. 35 shows a structural member according to yet another preferred embodiment;

FIG. 36 shows a structural member according to another preferred embodiment;

FIG. 37 shows yet another preferred embodiment of the structural member illustrating three different embodiments of the second meshing element; and

FIG. 38 shows the formation of the structural members of FIG. 37.

FIG. 39 is a side view of in partial cut-away first and second meshing elements of a structural member according to a further preferred embodiment;

FIGS. 40 to 49 show first and second meshing elements being moved into locking engagement with each other to form a structural article according to another preferred embodiment;

FIG. 50 shows the structural article of FIG. 49 configured to contain a glass;

FIGS. 51 to 53 show the formation of a structural member according to another preferred embodiment which encapsulates an object;

FIG. 54 shows a structural member similar to that shown in FIGS. 40 to 49;

FIG. 55 shows a structural member according to another preferred embodiment in the form of a square tube;

FIG. 56 shows a structural member according to another preferred embodiment similar to the embodiment of FIG. 55;

FIG. 57 shows a top view and a side view of the structural member of FIG. 56; and

FIG. 58 is an elevated perspective view of first and second meshing elements of a structural member according to another preferred embodiment;

FIGS. 59 to 66 show the meshing elements of FIG. 58 being moved into locking engagement with each other to form a structural member.

### DETAILED DESCRIPTION

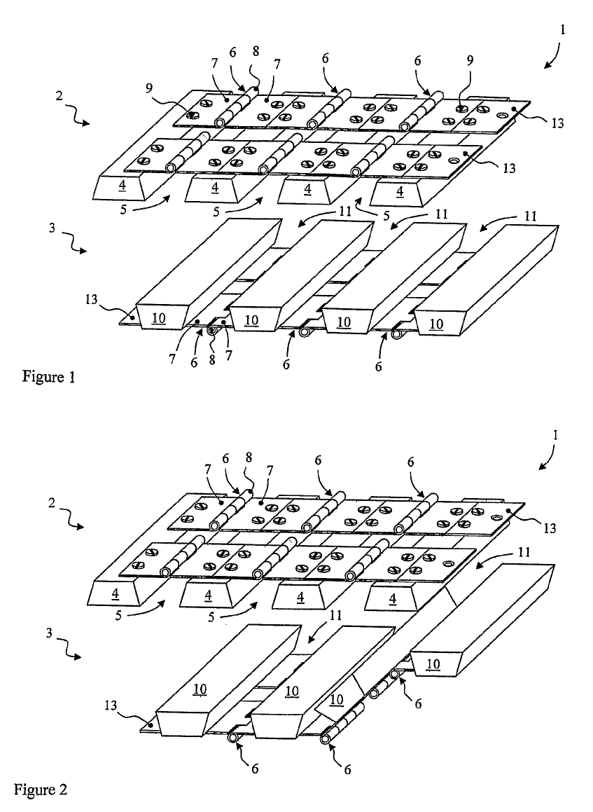

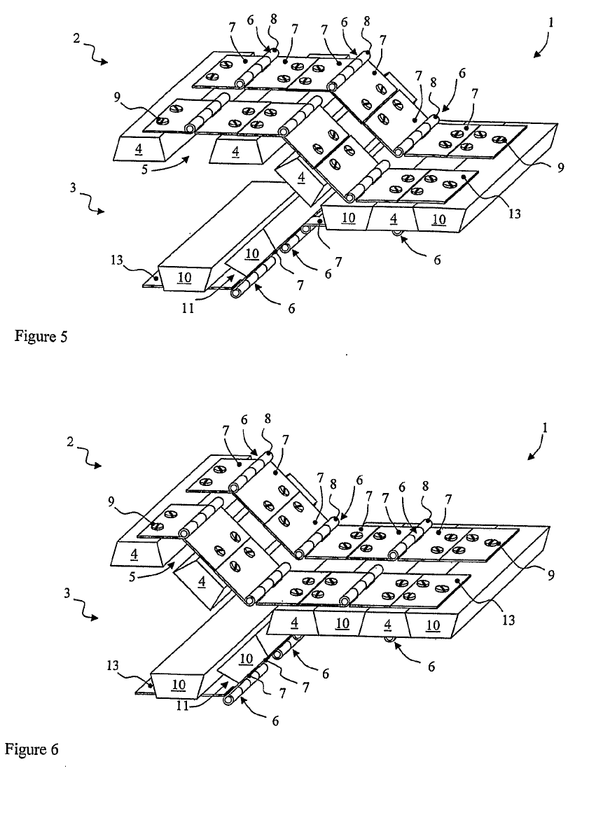

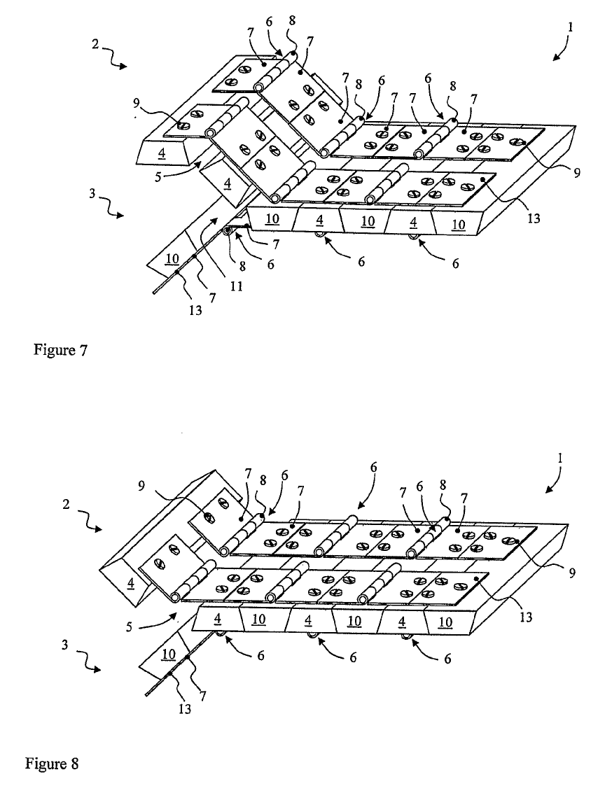

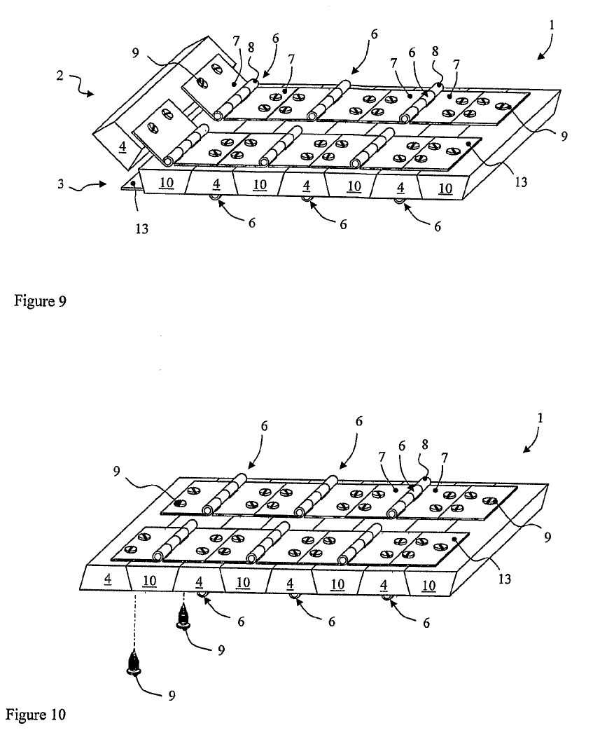

Referring to FIG. 1, there is shown a structural member 1 formed from a first meshing element 2 and a second meshing element 3. FIGS. 2 to 11 show the forming of the structural member 1 from the first meshing element 2 and the second meshing element 3. It is noted that in the drawings like reference numerals refer to like components.

The first meshing element 2 includes four trapezoidal prisms 4. The prisms are solid and formed from any preferred material. The four prisms 4 are disposed in a side-by-side arrangement and each prism 4 is connected to an adjacent prism 4 by means of a pair of spaced apart hinges 6 disposed intermediate the prisms 4. Each hinge 6 includes hinge arms 7 and a hinge point 8.

As shown in FIG. 1, the hinge point 8 of each hinge 6 is disposed substantially half way between the prisms 4 connected thereby. The hinge arms 7 are fixed to the prisms 4 by means of screws 9. The spaces between adjacent prisms 4 of the first meshing element 2 define three first meshing element engagement cavities 5.

The second meshing element 3 shown in FIG. 1 is substantially identical to the first meshing element 2. The element 3 also includes four trapezoidal prisms 10 disposed in a side-by-side arrangement. Each prism 10 is connected to an adjacent prism 10 by means of a pair of spaced apart hinges 6 disposed intermediate the prisms 10 being interconnected.

As with the connecting of prisms 4 in the first meshing element 2, each hinge 6 includes a hinge point 8 disposed substantially half way between the prisms 10. The hinge arms 7 is fixedly connected to the prisms 10 by means of screws 9. The spaces between the prisms 10 define second meshing element engagement cavities 11.

The prisms 10 of the second meshing element 3 are configured to be retained in the first meshing element engagement cavities 5. Likewise, the prisms 4 of the first meshing element 2 are configured to be retained in the second meshing element engagement cavities 11.

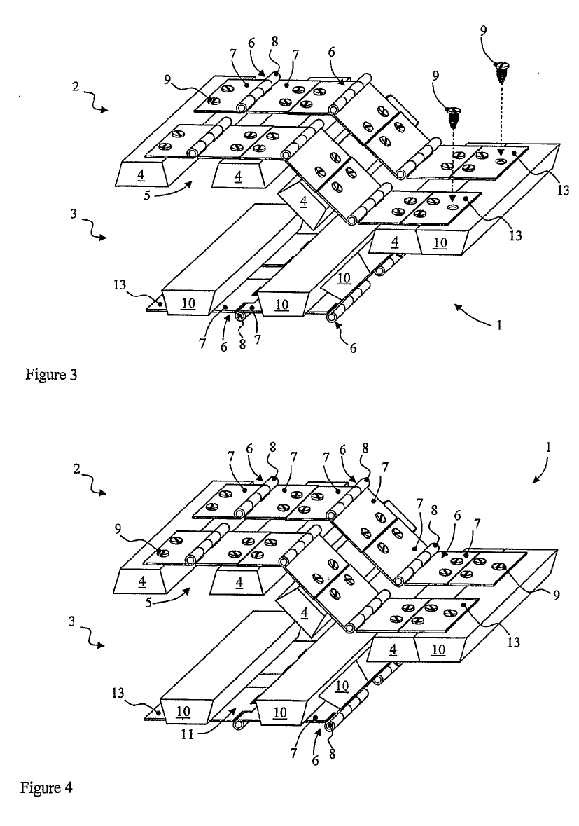

Referring particularly to FIGS. 2 to 11, there is shown the movement of the first and second meshing elements 2 and 3 so as to retainingly engage the prisms 4 and 10 with the cavities 11 and 5 respectively. FIG. 3, for example, shows an engagement cavity 11 of the second meshing element 3 receiving a prism 4 of the first meshing element 2. A locking plate 13 is attached to the received prism 4 and an end prism 10 of the second meshing element 3 to restrain movement of the hinge 6 so as to retain the prisms 4 and 10 engaged with engagement cavities 11 and 5.

Each prism 10 is received in an engagement cavity 5 and likewise each prism 4 is received in an engagement cavity 11. The end prism 10 of the second meshing element 3 includes a locking plate 13. The locking plate is screwed to an end prism 4 of the first meshing element. In this way, the ends of each meshing element 2 and 3 are fixed to each other thereby locking all of the prisms 4 and 10 into respective engagement cavities 11 and 5, forming the structural member 1.

It is noted that the locking device does not necessarily need to be fastened to prisms at the ends of the meshing elements 2 and 3 but this can be achieved by the proximity of the prisms along and the locking device is configured to prevent the prisms from moving apart once engaged.

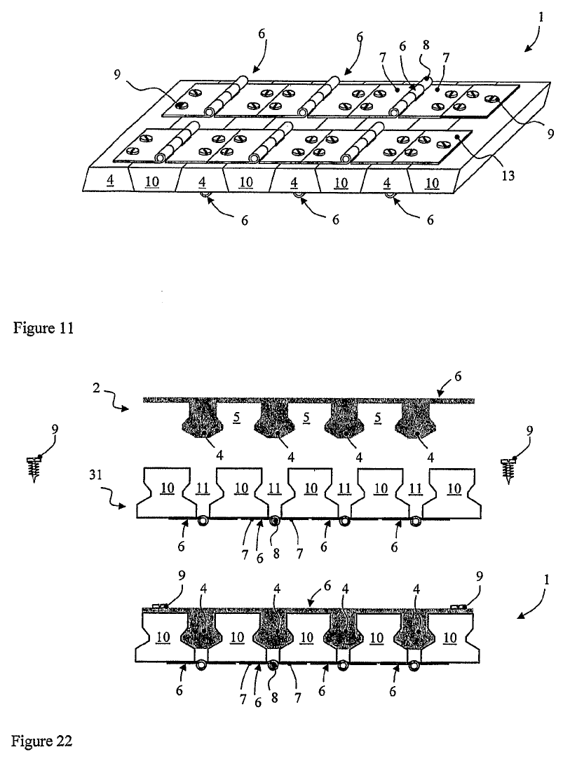

As can be seen, the prisms 4 and 10 and the engagement cavities 5 and 11 are of substantially the same shape. Thus, the structural member 1 shown in FIG. 11 is substantially planar. However, it will be appreciated that the first and second meshing elements 2 and 3 can be rolled up when disengaged from each other.

It will also be appreciated that many variations to the preferred embodiment of the structural member 1 shown in FIGS. 1 to 11 can be made. For example, the prisms and engagement cavities, whether adjacent or not, can be any preferred shape. The prisms can be formed from a solid of a preferred material such as plastics, wood, metal, etc. The prisms can also be formed as an assembly of prism components provided in an unassembled form. Furthermore, the prisms can be formed from outer or skeletal frames which themselves may be collapsible. It is also noted the prisms can vary in cross-sectional shape along their length.

It will also be appreciated that the number of prisms 4 and 10 on each of the first and second meshing elements 2 and 3 can be any desired. Further, the number of prisms on the first meshing element 2, for example, can be one more than on the second meshing element 3. In this way, a locking plate 13 (not illustrated) is disposed at each end of the second meshing element 3 and extending outwardly therefrom and are screwed into the end prisms 4 of the first meshing element 2. A locking plate 13 does not need to be disposed at one end of each meshing element 2 and 3 as shown in FIG. 1. It is also noted any preferred means other than screws 9 can be used to affix the locking plates 13 to the prisms 4 or 10.

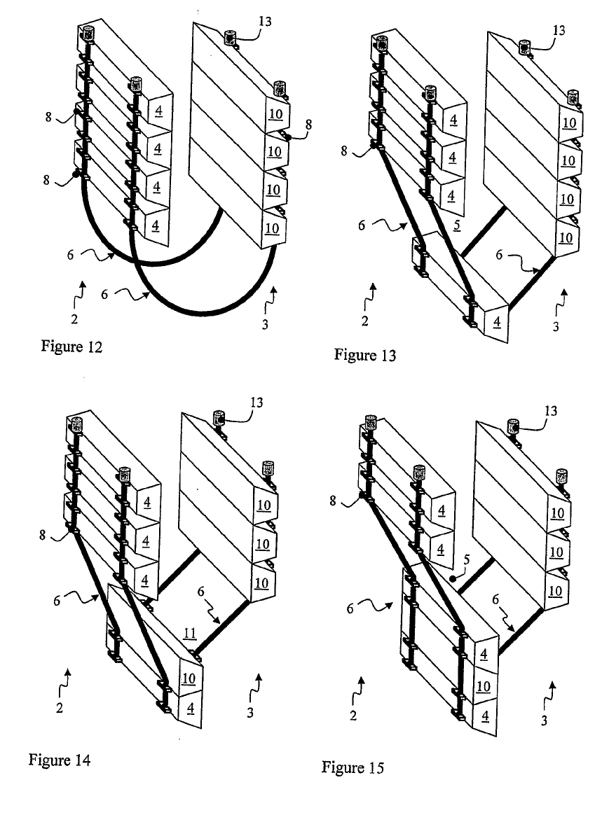

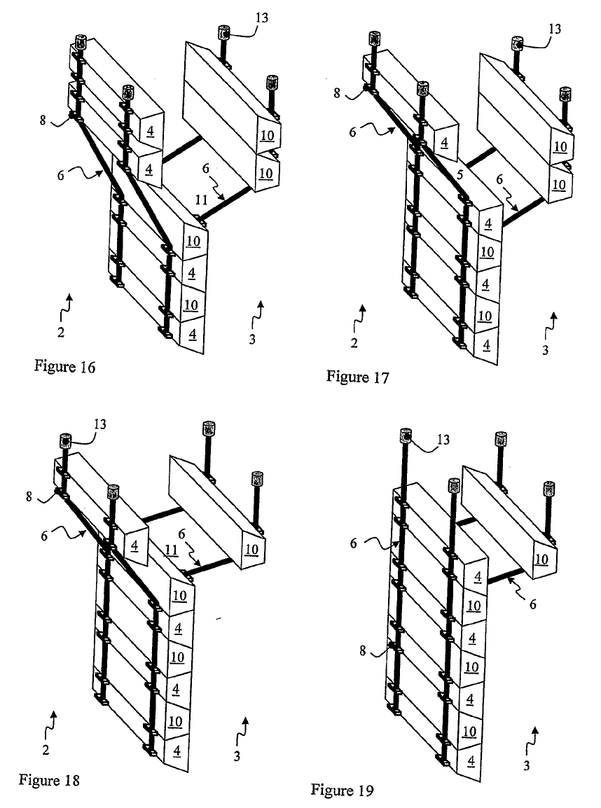

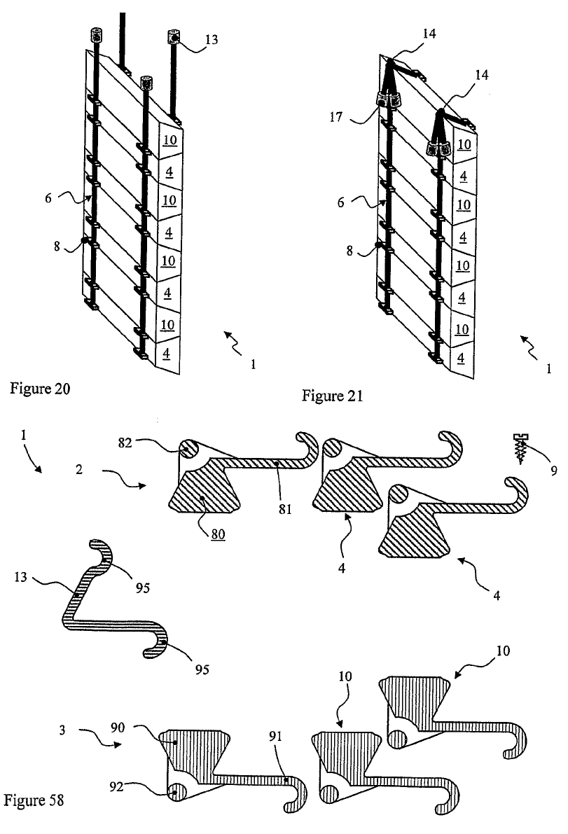

Referring to FIG. 12, there is shown a structural member 1 according to another preferred embodiment. The structural member 1 of this embodiment is formed from a first meshing element 2 and a second meshing element 3. FIGS. 13 to 21 show the forming of the structural member 1 from the first meshing element 2 and the second meshing element 3. It is noted again that in the drawings like reference numerals refer to like components.

In the embodiment of FIG. 12, the first meshing element 2 includes four trapezoidal prisms 4. The prisms are solid and formed from any preferred material. The four prisms 4 are disposed in a side-by-side arrangement and each prism 4 is connected to an adjacent prism 4 by means of a pair of spaced apart hinges 6 in the form of a flexible or elastic cable disposed intermediate the prisms 4. The hinge cable 6 can be rod-like or strip-like or any other preferred shape.

The prisms 4 and 10 are each slidably mounted to the hinge 6 (cable) so that the effective hinge point 8 is determined by the distance intermediate prisms 4 or 10. In this way, movement of the prisms 4 or 10 along the hinge cable 6 can vary the first and second meshing element cavities 5 and 11 intermediate the prisms 4 and 10. That is, the meshing element cavities 5 and 11 can be selectively varied to allow space to receive a prism 10 or 4 respectively and then close up adjacent a prism 10 and 4 once received in cavities 5 and 11. It will be appreciated that the hinge cable 6 still includes hinge arms 7 and a hinge point 8, however, these are not fixed along the cable length. That is, as a prism 4 or 10 is moved into or out of engagement with a cavity 11 and 5 and along the cable 6, the hinge point 8 caused by the engagement moves accordingly along the cable and either side of the hinge point 8.

In this embodiment, hinge arms 7 (formed from the cable) either side of hinge point 8 are slidably mounted to the prisms 4 and 10 by means of retaining clips 9. The spaces between adjacent prisms 4 of the first meshing element 2 define the three first meshing element engagement cavities 5.

The second meshing element 3 shown in FIG. 12 is substantially identical to the first meshing element 2. The element 3 also includes four trapezoidal prisms 10 disposed in a side-by-side arrangement. Each prism 10 is connected to an adjacent prism 10 by means of a pair of spaced apart hinges 6 disposed intermediate the prisms 10 being interconnected.

Similarly to the connecting of prisms 4 in the first meshing element 2, each hinge 6 includes a hinge point 8 disposed intermediate the prisms 10. The hinge arms 7 (formed from the cable) are fixedly connected to the prisms 10 by means of retaining clips 9. The spaces between the prisms 10 define second meshing element engagement cavities 11.

The prisms 10 of the second meshing element 3 are configured to be retained in the first meshing element engagement cavities 5. Likewise, the prisms 4 of the first meshing element 2 are configured to be retained in the second meshing element engagement cavities 11.

Similarly to the description of the first preferred embodiment, FIGS. 13 to 21 show the movement of the first and second meshing elements 2 and 3 so as to retainingly engage the prisms 4 and 10 with the cavities 11 and 5 respectively. A loop closing plate 13 is attached to the end of each cable 6 such that the prisms 4 and 10 are retained within the ends of the cable by the retaining clips 9.

Each prism 10 is received in an engagement cavity 5 and likewise each prism 4 is received in an engagement cavity 11. In this way, the ends of each meshing element 2 and 3 are fixed to each other thereby locking all of the prisms 4 and 10 into respective engagement cavities 11 and 5, forming the structural member 1. In the embodiment of FIGS. 12 to 21, the loop closing plates 13 are tied together in a locking knot 14 so as to lock the elements 2 and 3 together.

As can be seen, the prisms 4 and 10 and the engagement cavities 5 and 11 are of substantially the same shape. Thus, the structural member 1 shown in FIG. 21 is substantially planar. However, it will be appreciated that the first and second meshing elements 2 and 3 can be rolled up when disengaged from each other.

It will also be appreciated that many variations to the preferred embodiment of the structural member 1 shown in FIGS. 1 to 11 and FIGS. 12 to 21 can be made. For example, the prisms and engagement cavities, whether adjacent or not, can be any preferred shape. The prisms can be formed from a solid of a preferred material such as plastics, wood, metal, etc. The prisms can also be formed as an assembly of prism components provided in an unassembled form. Furthermore, the prisms can be formed from outer or skeletal frames which themselves may be collapsible. It is also noted the prisms can vary in cross-sectional shape along their length.

It will be further appreciated that the number of prisms 4 and 10 on each of the first and second meshing elements 2 and 3 can be any desired. Further, the number of prisms on the first meshing element 2, for example, can be one more than on the second meshing element 3. In this way, a locking plate 13 or knot 14 (depending on the preferred embodiment) can be disposed at each end of the second meshing element 3 and extending outwardly therefrom and are screwed into the end prisms 4 of the first meshing element 2. A locking plate 13 does not need to be disposed at one end of each meshing element 2 and 3 as shown in FIG. 1. It is also noted any preferred means other than screws 9 or retaining clips 9 can be used to affix the locking plates 13 to the prisms 4 or 10.

Turning now to FIGS. 22 to 26, there is shown another preferred embodiment of the first meshing element 3 and it is noted again that like reference numerals are used to refer to like components. Below the first meshing element 3 in respective Figs. is shown five preferred shaped second meshing elements 31, 32, 33, 34 and 35 that are configured to mesh therewith. The first meshing element 2 is very similar to that shown in the first preferred embodiment except that in FIG. 26 the adjacent prisms 4 are contiguous with another along an upper portion 12. Again, each prism 4 is connected to an adjacent prism by means of the hinge 6. The upper portions 12 move away from each other upon movement of the hinges 6 to allow prisms 10 to be received in engagement cavities 5.

In FIG. 22, the second meshing element 31 includes a plurality of periodically spaced apart prisms 10, where each of the prisms 10 are of the same shape and are larger than the engagement cavities 5. Each prism 10 is non-trapezoidal and is integrally formed with a single hinge element 6 in the form of a resiliently biased strip material that is substantially longitudinally inextensible but transversely bendable to provide a hinging motion. In this way, the resilient strip material intermediate each prism 10 behaves as a separate hinge. It will be apparent that the hinges can be formed from flexible or elastic materials, and can be integral with adjacent prisms.

In FIG. 24, the second meshing element 32 includes a plurality of periodically spaced apart prisms 10, however, these prisms 10 are larger than those of the second meshing element 31. As shown in FIG. 26, the second meshing element 33 includes a pair of prisms 10 similar to those of second meshing element 31, however, a gap is left intermediate the two adjacent prisms 10 and the outer prism 10 is of larger proportions than the other two.

When the prisms 10 are brought into engagement with engagement cavities 5, and prisms 4 into engagement with engagement cavities 11 in a like manner as the first embodiment shown in FIGS. 1 to 11, a contoured structural member 1 is provided. When the second meshing element 32 of FIG. 24 is engaged with the first meshing element 2, the prisms 10 of the second meshing element 31 are larger than the engagement cavities 5 causing the structural member 1 to be contoured.

When the second meshing element 32 is moved into engagement with the first meshing element 2, an arched structure is formed. This is because the prisms 10 are all the same size and the prisms 4 are caused to be uniformly spaced apart providing the arch.

In FIG. 26, when the second meshing element 33 is engaged with the first meshing element 2 to form the structural element 1, a contoured portion is provided for the evenly spaced apart prisms 10 when engaged in engagement cavities 5 and a flat or substantially planar section is formed where the engagement cavity 5 is not engaged with a prism 10. Where the largest prism 10 of the second meshing element 33 (similar to those of the second meshing element 32) is engaged with the first meshing element 2, a more arched portion is provided.

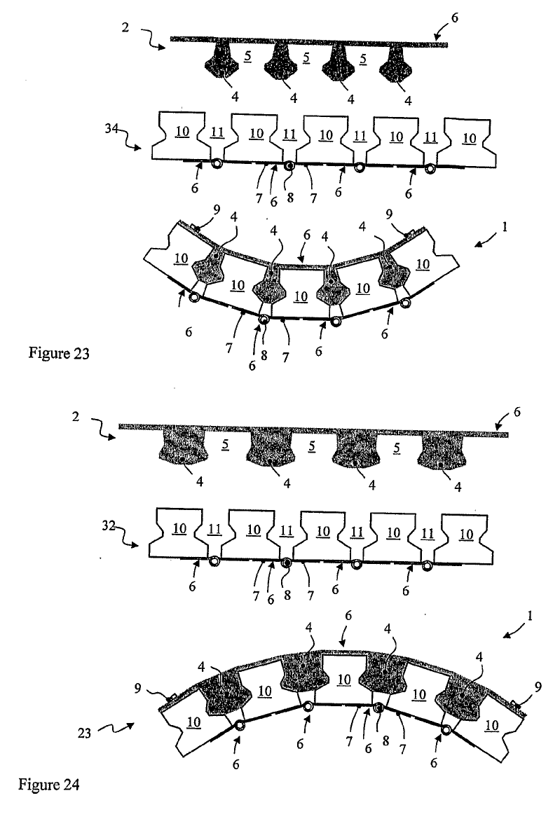

In FIG. 23, the second meshing element 34 includes a plurality of periodically spaced apart prisms 4, however, these prisms 4 are smaller than those of the second meshing element 31. As shown, when the prisms 10 are brought into engagement with engagement cavities 5, and prisms 4 into engagement with engagement cavities 11 in a like manner as the first embodiment shown in FIGS. 1 to 11, for example, a contoured structural member 1 is provided. When the second meshing element 31 is engaged with the first meshing element 2, the prisms 10 of the second meshing element 31 are larger than the engagement cavities 5 causing the structural member 1 to be contoured in the opposite direction (compare with FIG. 24).

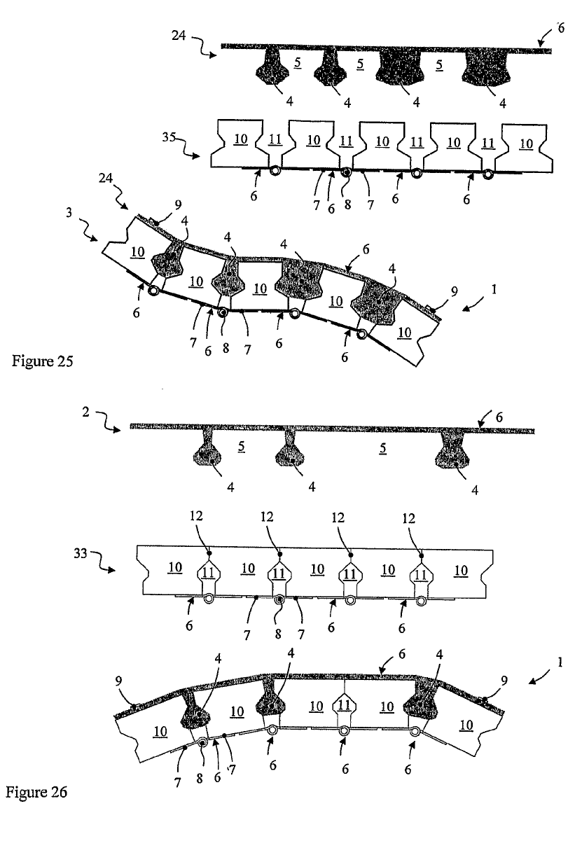

In FIG. 25, adjacent prisms 4 are varied in size so that when the second meshing element 35 is moved into engaged with the first meshing element 2, a wavy structure is formed. This is because some of the prisms 4 are all the same size and the cavities 11 are uniformly spaced apart providing the wave. It will be appreciated that the prisms 10 or the cavities 11 can be any preferred size and shapes, whether the same as any other prism or cavity or not.

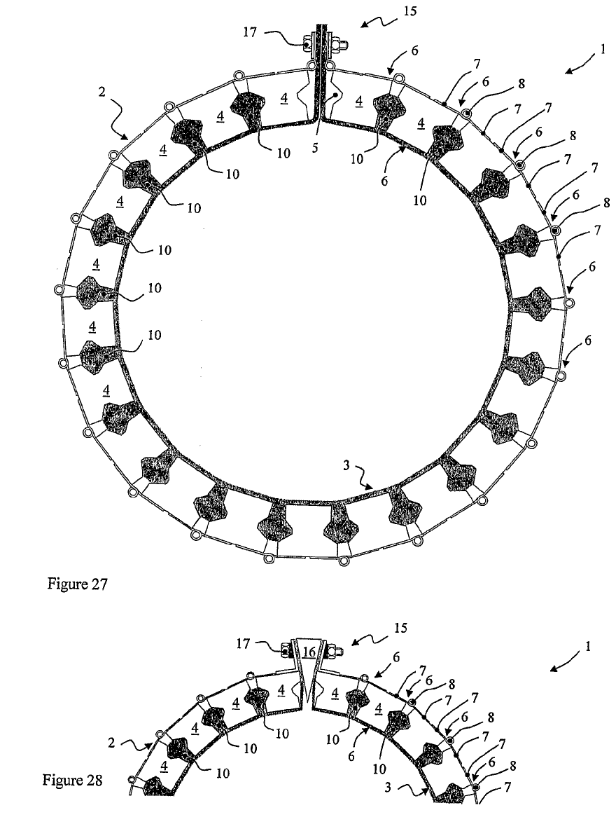

Turning to FIG. 27, there is shown a structural member 1 formed from a second meshing element 3 that is similar to second meshing element 32 of FIG. 23. The structural member 1 of this embodiment is arched so as to form a closed loop. As best shown in FIG. 28, each end of the structural member 1 is attached by means of a single clamping arrangement 15. It is noted that a locking prism in the form of a wedge like pin 16 is received intermediate prisms 4 of the first meshing element 2 and no hinge is provided therebetween. A bolt 17 secures the ends of the second meshing element 3 about the wedge like pin 16 thereby securing the ends of the first and second meshing elements 2 and 3.

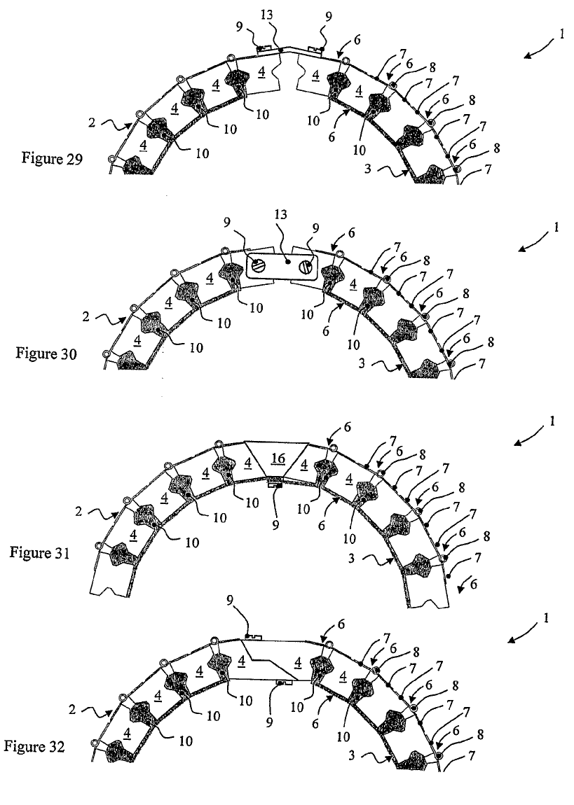

FIGS. 29 and 30 show the use of locking plate 13 to affix the ends of the loop of the structural element 1 together. FIG. 31 shows the use of wedge 16 and screw 9 to lock the ends of the structural loop element 1 together. In FIG. 32, mated prisms 4 are affixed together with a pair of screws. However, it will be understood that any preferred fixing means can be used.

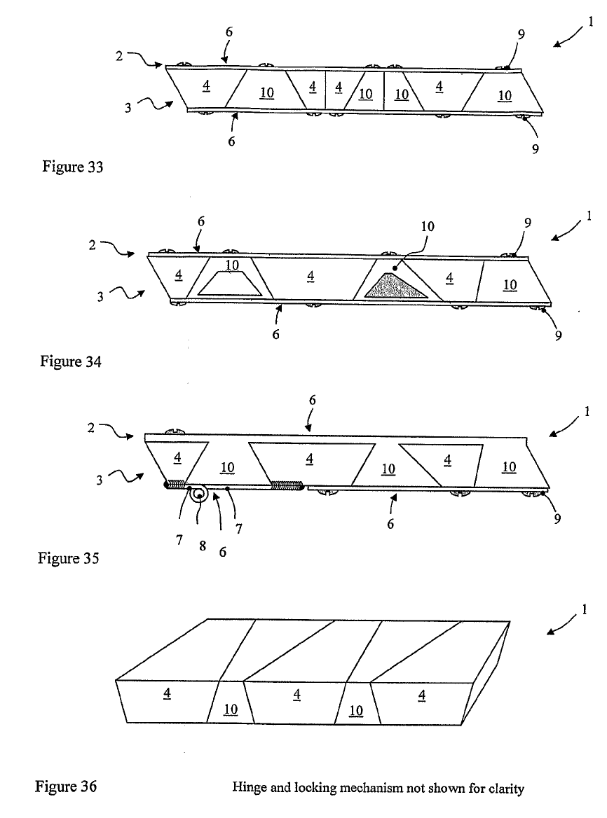

In FIG. 33, there shown a structural member 1 where one of the prisms 4 and one of the prisms 10 are formed from two component prism parts. However, the prisms 4 or 10 can be formed from a single material or from any preferred number of component parts.

In FIG. 34, there shown a structural member 1 where all of the prisms 4 of the first element 2 differ in shape from each other and all of the prisms 10 of the second element 3 differ from each other, or can be hollow. The structural member 1 formed in this embodiment by the engagement of the first and second meshing elements 2 and 3 is substantially planar. The hinges are connected to the prisms 4 and 10 by means of screws, however, any preferred connection means can be employed.

In FIG. 35, there is shown a substantially planar structural member 1. The prisms 4 of the first meshing element 2 are formed from rubber and are integrally formed with resilient rubber hinges 6. Some prisms 10 of the second meshing element 3 are connected to a resilient strip like hinge 6 (a rubber strip for example) by means of a screw 9, and others are welded or glued or otherwise adhered to a conventional plate like hinge 6. It will be appreciated that any different number and types of hinges 6 can be used to allow movement of the meshing elements 2 and 3 into and out of engagement.

In FIG. 36, there is shown an elevated perspective of engaged prisms 4 and 10 without the hinges 6 being shown. In this embodiment, it can be seen that the prisms are solid and vary in cross-section along their lengths. A substantially planar structural member 1 is provided in this embodiment.

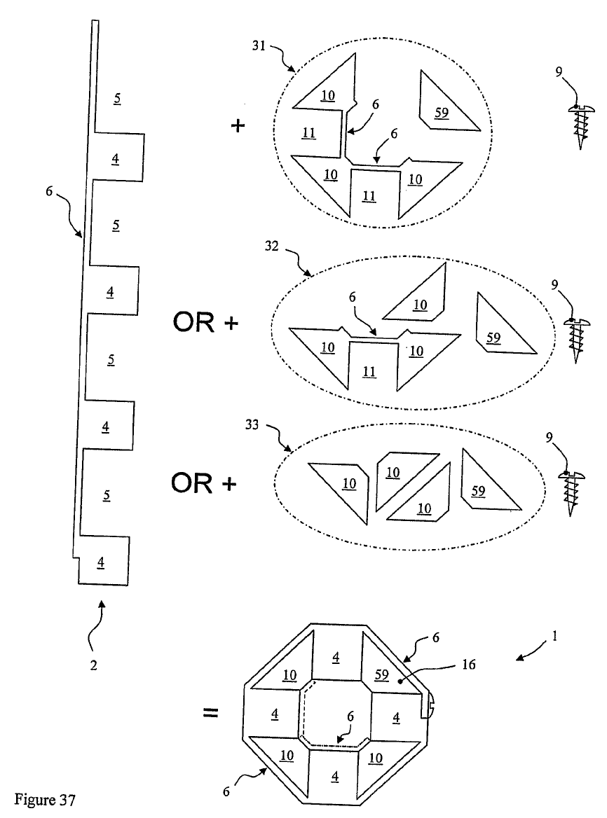

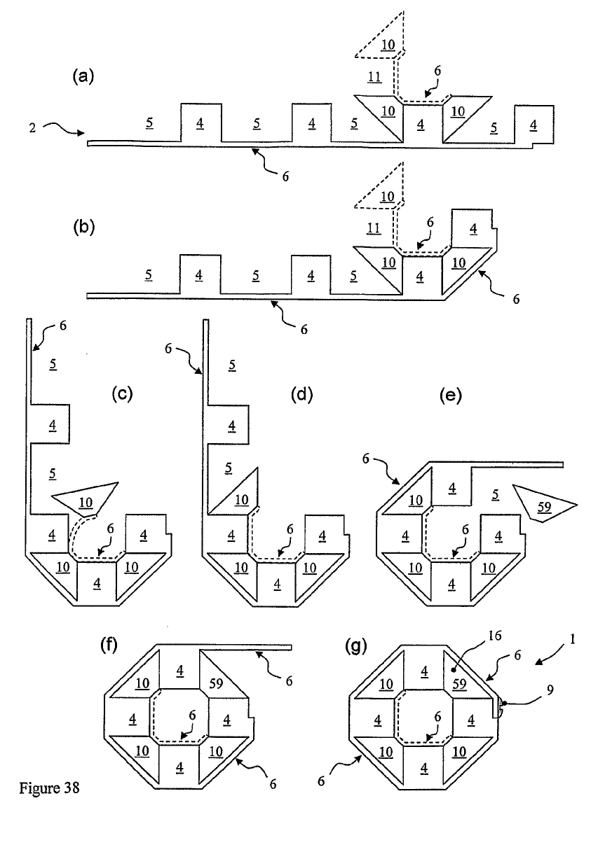

Turning to FIGS. 37 and 38, there is shown yet another embodiment of the structural member 1. As throughout this specification, like reference numerals refer to like components. The unassembled components of the member 1 are shown in the top part of the Fig., and the assembled member 1 at bottom. A single first meshing element 2 having a plurality of prisms 4 is shown top left, and below this are three different preferred embodiments of the second meshing element 3 shown to the right.

The upper shown second meshing element 3 includes three prisms 10 disposed in a side-by-side arrangement and interconnected by a resilient flexible hinge 6. Also shown is a locking prism 59 and a screw 9. In this embodiment, the engagement cavities 5 of the first meshing element 2 receive the three prisms 10. The locking prism 59 is received intermediate the initial and final prisms 4 of the first meshing element 2. The end strip material of the first meshing element 2 is folded over the locking prism 59 and the structural member is locked with the screw 9.

The middle or second embodiment of the second meshing element 3 shown in FIG. 37 includes two prisms 10 disposed in a side-by-side arrangement and interconnected by a resilient flexible hinge 6. A third prism 10 is separate from the other prims 10. In this embodiment, the first two engagement cavities 5 of the first meshing element 2 receive the two prisms 10. The third prism 10 is inserted into an engagement cavity 5 before the final prism 4 of the first meshing element 2 is located in the position shown. The final prism 10 of the second meshing element 3 is in the form of locking prism 59 and is received intermediate the initial and final prisms 4 of the first meshing element 2. The end strip material of the first meshing element 2 is folded over the locking prism 59 and the structural member 1 is locked with the screw 9.

In the third type of second meshing element 3 shown bottom right, all of the prisms on the second meshing element 3 are discrete. These are in turn inserted into the engagement cavities 5 of the first meshing element 2 during the formation of the structural member 1. The locking prism 59 is received intermediate the initial and final prisms 4 of the first meshing element 2. The end strip material of the first meshing element is folded over the locking prism 59 and the structural member 1 is locked with a screw 9.

FIG. 38 shows the steps involved in forming the structural member 1 of FIG. 37 from the first meshing element 2 and the various types of second meshing element 3. The use of the first meshing element 3 the first embodiment of FIG. 37 is particularly shown, however, it will be apparent to those skilled in the art that FIG. 38 also illustrates the formation of the structural member 1 from the second and third embodiments of the second element 3 of FIG. 37 if one or all of the prisms of FIG. 38 are not connected by the flexible resilient hinge 6.

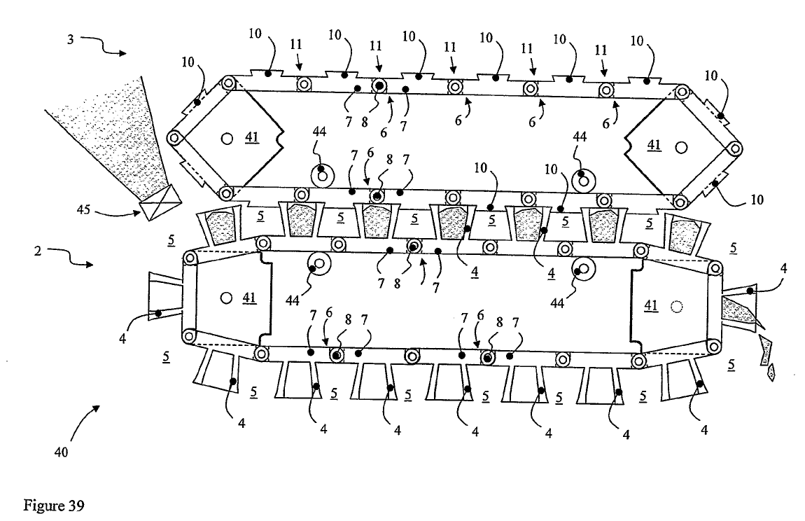

FIG. 39 is a side view in partial cut-away of first and second meshing elements 2 and 3 that are used to form a structural member 40 in the form of a self-supporting conveyor system. The first and second meshing elements 2 and 3 are formed into closed loops and it is noted a locking plate, clamping arrangement or the like is not shown.

The loop of the first meshing element 2 is disposed below the loop of the second meshing element 3. Each looped meshing element 2 and 3 is supported at each end by hubs 41 that are configured to rotatably drive the loops of the meshing elements 2 and 3 at the same rotational speed. It can be seen that the prisms 4 of the first meshing element 2 are substantially hollow with an opening to allow the prisms to be used as material containers. The spaces intermediate adjacent prisms 4 provides engagement cavities 5.

As the first meshing element 2 is rotated, a prism 4 is moved adjacent a metered dispenser 45 that is configured to dispense a predetermined amount of a material into a prism 4 as it moves thereby. As the prisms 4 rotate past the dispenser 45, they engage with engagement cavities 11 of the second meshing element 3 and the prisms 10 of the second meshing element 3 engage with the engagement cavities 5.

Two pairs of locking rollers 44 are provided to serve the same function as the locking plate 13. That is, when the engaged first and second meshing elements 2 and 3 are moved into engagement, the locking rollers 44 prevent the hinge elements 6 from moving thereby causing locking engagement and a structural member 40 is formed. As the engaged first and second meshing elements 2 and 3 rotate and move past the second locking rollers 44 (shown as the right-hand side pair), the hinges 6 are free to move thereby disengaging prisms 10 from engagement cavities 5 and prisms 4 from engagement cavities 11. At this time, the material dispensed into a prism 4 is removed under gravity as the first meshing element 2 is rotated.

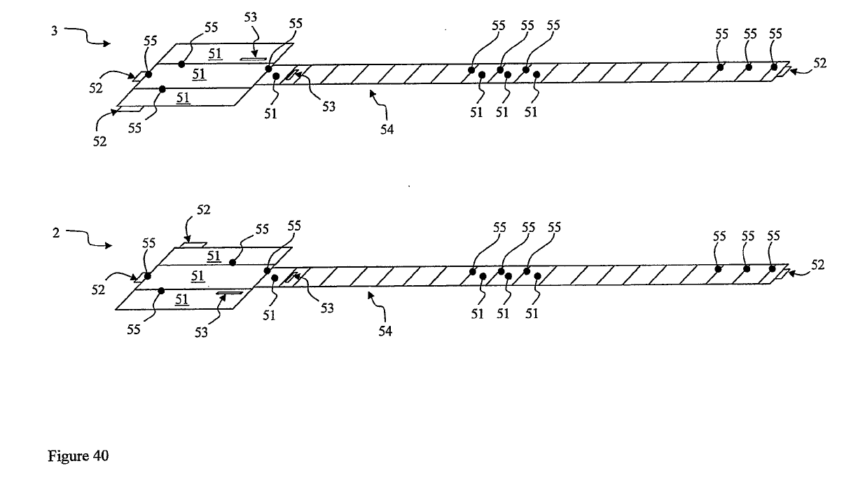

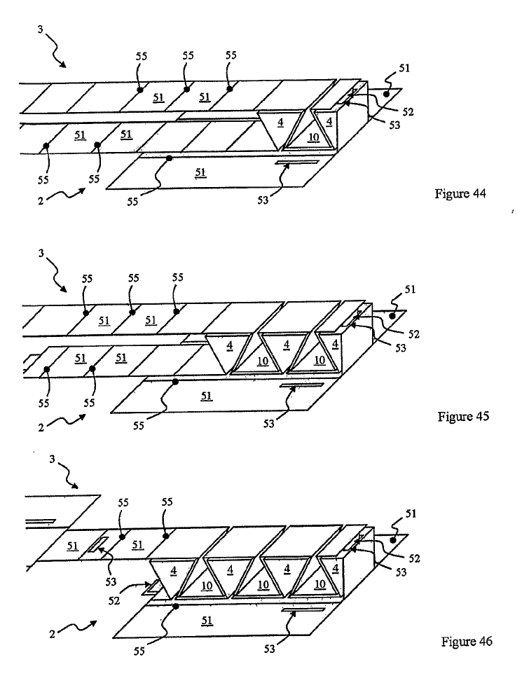

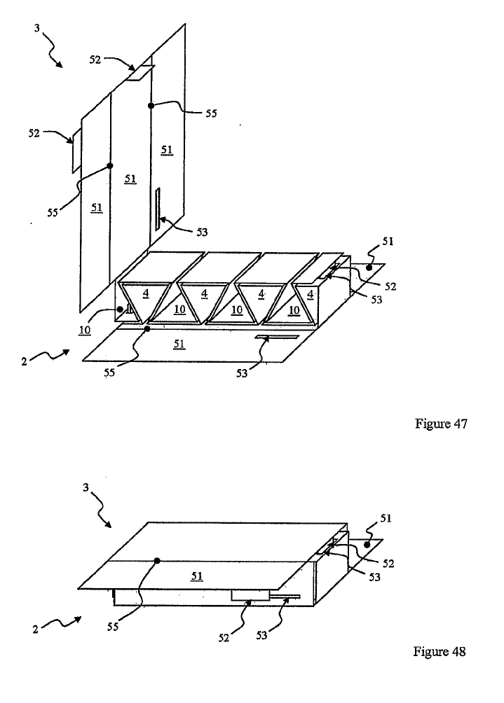

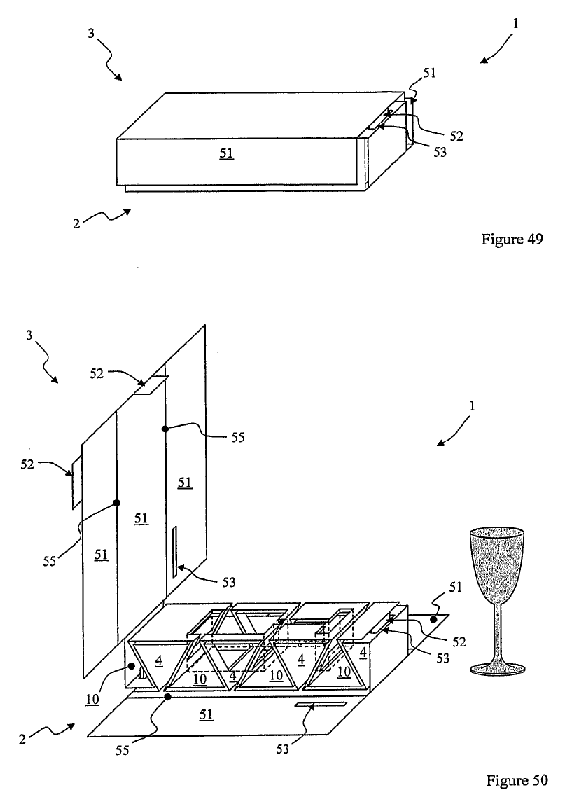

Referring to FIGS. 40 to 49, there is shown another preferred embodiment of the present invention wherein the structural member 1 is a box. The meshing elements 2 and 3 are formed from identical fibreboard blanks. The blanks are shaped to include a plurality of flaps 51 and tabs 52 defined by fold lines 55 in the fibreboard. The blanks 2 and 3 also include a pair of slots 53 configured to receive tabs 52 of the blanks 3 and 2. The blanks 2 and 3 each include strips 54 having fold lines 55 such that each strip 54 can be folded in an interleaved manner with each other wherein the folding of the strips 54 provides prisms 4 and 10 and engagement cavities 5 and 11.

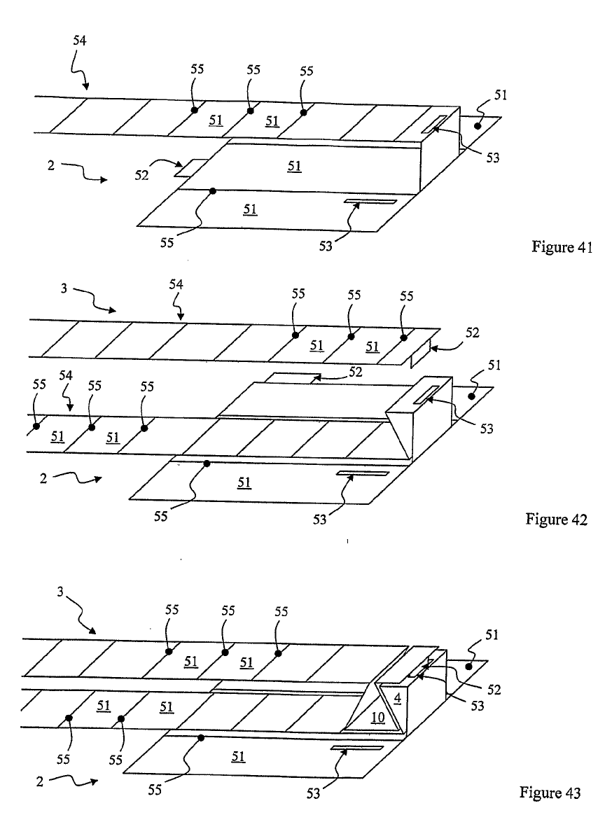

FIGS. 41 to 49 show the folding of the blanks 2 and 3 to form the structural member 1. In FIG. 41, the first meshing element 2 is folded to provide a prism 4 with flaps 51 forming a base and two unfolded sidewalls. A slot 53 of meshing element 3 is formed in the first prism 4, the slot 53 to be used with a tab 52 of the second meshing element 3 to lock the two elements 2 and 3 together.

FIG. 42 shows the movement of the second meshing element 3 so that a tab 52 at the end of strip 54 is configured for locking engagement with the slot 53. Once engaged, the strip 54 of the second meshing element 3 is folded along a fold line 55 so as to form a prism 10. A prism 4 of the first meshing element 2 is formed adjacent thereto by folding the strip 54 along fold lines 55. The strips 54 of the first and second meshing elements 2 and 3 are alternately folded along fold lines 55.

As best seen in FIG. 46, a structural member 1 is formed by interleaving the prisms 4 and 10 so that the creation of engagement cavities 5 and 11 occurs by forming adjacent prisms 10 and 4 when folding the strips 54. That is, each fold line 55 of the strips 54 behave like a hinge 6 where the hinge arms are integral with the prisms 4 and 10.

FIGS. 47 to 49 best show the engagement of the first and second meshing elements 2 and 3 where the flaps 51 are folded to envelope the engaged prisms and cavities. FIG. 50 shows a structural member 1 that is very similar to that shown in FIGS. 40 to 49 except that the strips 54 include cut-out regions that are configured to receive a glass therein when folded. It will be appreciated that the cut-out regions can shaped to receive any preferred item.

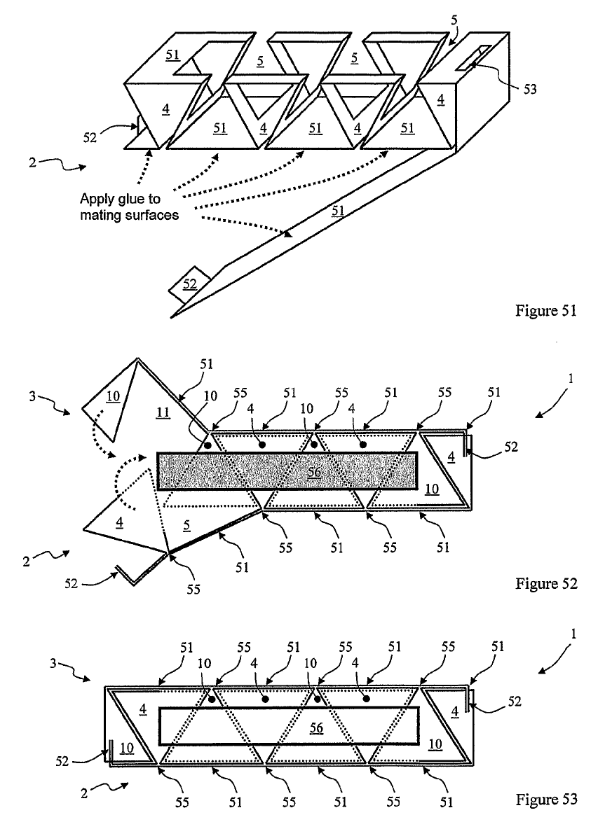

Referring to FIGS. 51 to 53, there is shown a structural member formed similarly to that shown in FIGS. 40 to 49. In this embodiment, an adhesive is applied to various folded parts of the first meshing element 2 of the structural member 1, as best shown in FIG. 51. It will be appreciated that the structural member 1 is formed by folding the meshing element sheets 2 and 3 so as to form engaged prisms and cavities as with the case of FIGS. 40 to 47 but in this case, a discrete object to be packed in the structural member 1 is disposed within the cut-away portion in the prisms and cavities. Although not illustrated, it will be appreciated that the meshing elements 2 and/or 3 can be formed from a single folded piece of fibreboard or from multiple sheets which are adhered together to form the meshing element.

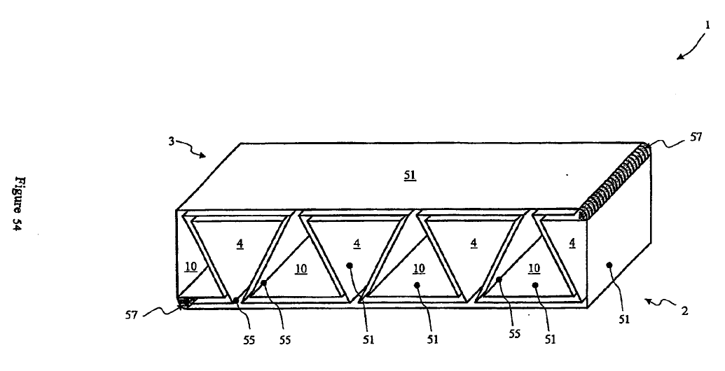

In this way, the package 1 is provided to a stage where the object 56 to be packed is disposed within and the remaining folds applied to the members 2 and 3 until the object is encapsulated with the structural member package 1. Once glued in a manner as shown in FIG. 51, it will be appreciated that the meshing elements 2 and 3 can be disengaged and re-engaged in a manner alike FIGS. 1 to 11 (for example) and as shown in FIG. 52 to form a structural member 1 that encapsulates the discrete object 56 as shown in FIG. 53.

Referring now to FIG. 54, there is shown another preferred embodiment of the structural member 1 also in the form of a box composed from a fibreboard, sheet metal or other material. In this embodiment, the box 1 does not include engagement flaps, tabs or slots. In fibreboard embodiments, glue, staples or other mechanical or chemical fasteners can be used. In the case of a sheet metal box 1, welds or solder 57, for example, can be used to retainingly connect the sheet material in the formation of the box 1.

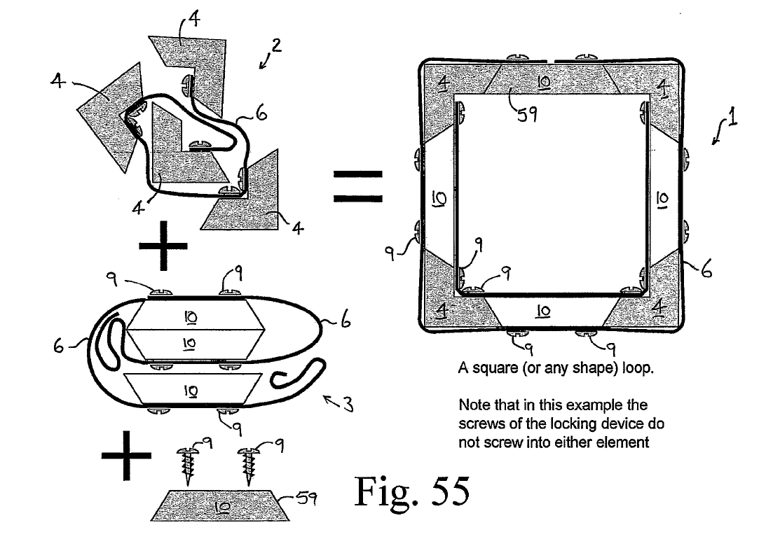

In FIG. 55 there is schematically shown at right an end view of a structural member 1 in the form of a square tube when assembled. Shown at left are first and second elements 2 and 3 and a locking prism 59 in an unassembled configuration.

It can be seen that the prisms 10 of the second element 3 are engaged with the engagement cavities (not shown) of the first element 2 and the locking prism 59 is disposed last so as to lock the configuration of the structural member 1 into shape thereby allowing it to bear loads, impacts, etc. It can be seen that this embodiment advantageously does not screw or directly affix the locking prism 59 to any of the prisms 4 or 10 but instead to the ends of the hinge element 6 at each end of the first element 2 are screwed to locking prism 59.

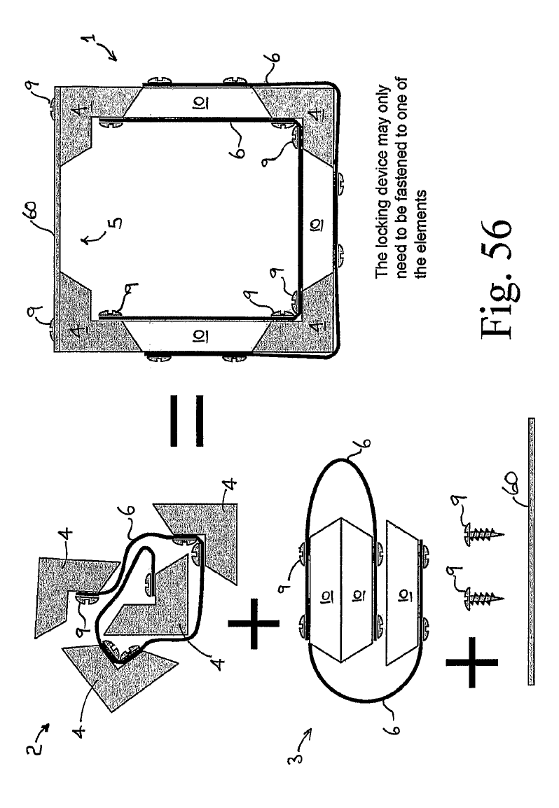

FIG. 56 is similar to FIG. 33 except that the locking device is a plate 60 rather than a locking prism 59. The locking plate 60 is screwed to two prisms 4 of the first meshing element 2 when assembled.

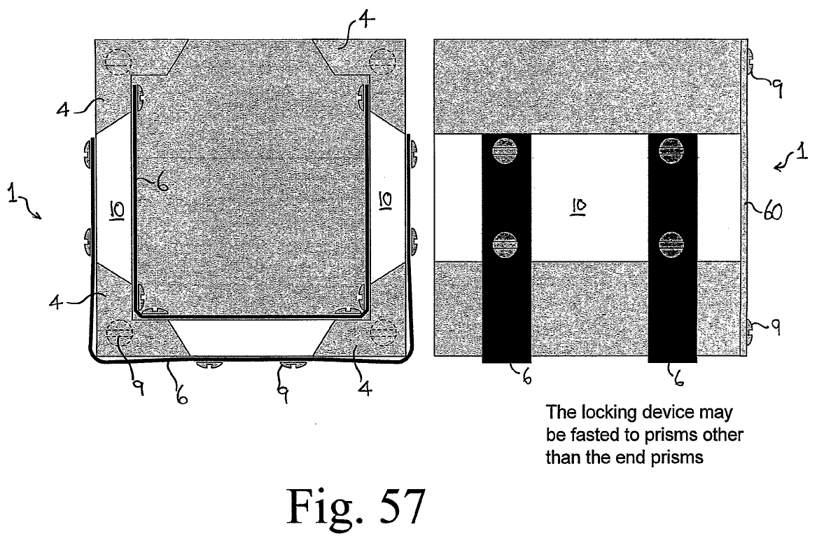

FIG. 57 shows a top (left) and side (right) view of the structural member 1 of FIG. 56 except that a locking plate 60 is fastened over end of the tubular structural member 1 to the prisms 4. Multiple hinges 6 of strip material in a side-by-side arrangement are shown in the side view.

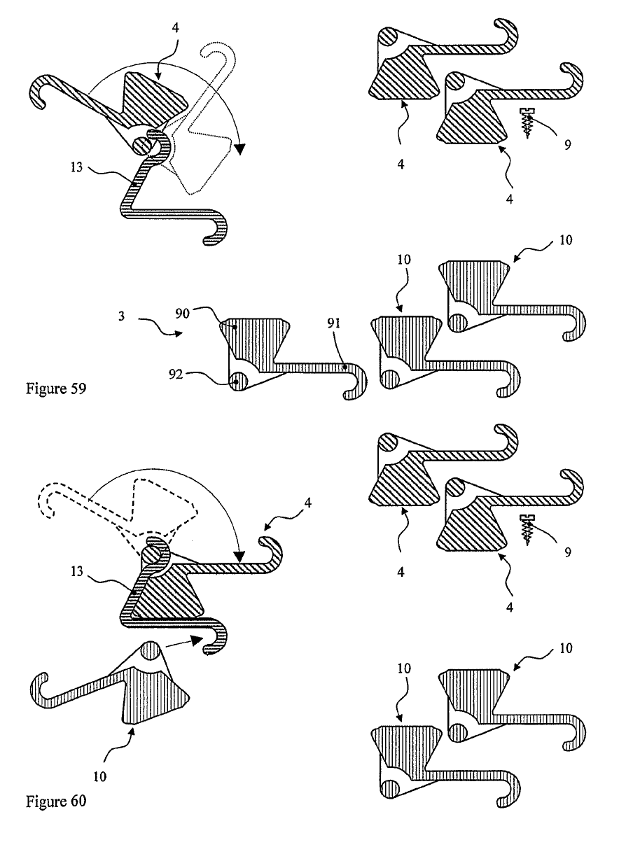

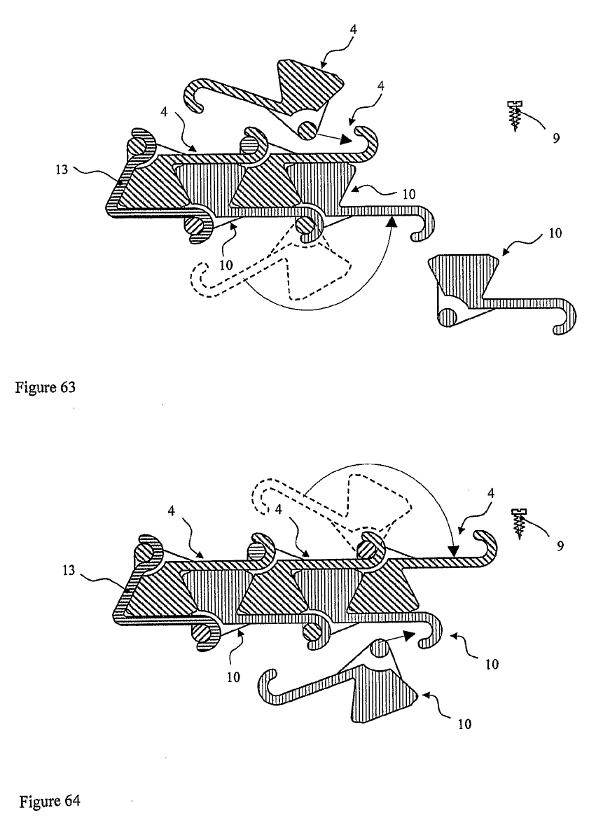

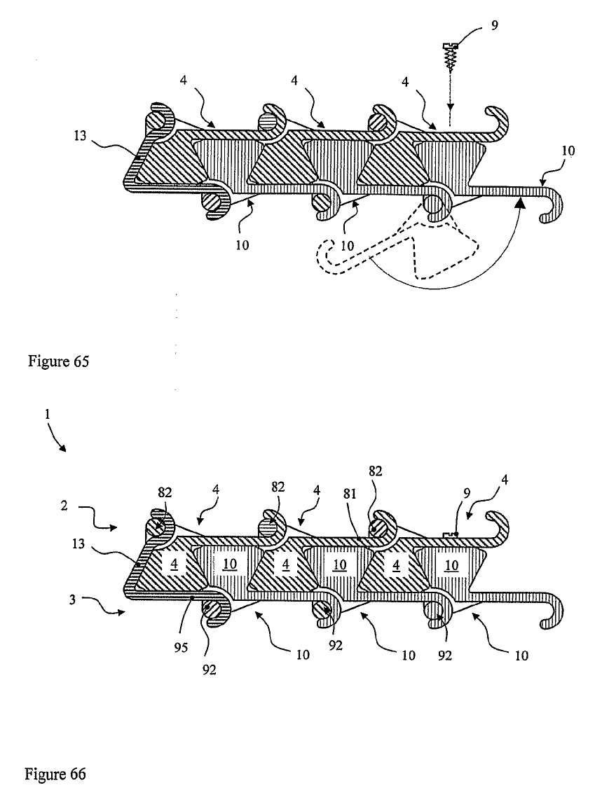

Reference is now made to FIGS. 58 to 66 which show a side view of yet another preferred embodiment of the structural member 1. Referring to FIG. 1, there is shown a structural member 1 formed from a first meshing element 2 and a second meshing element 3. FIGS. 59 to 66 show the forming of the structural member 1 from the first meshing element 2 and the second meshing element 3. It is again noted that in the drawings like reference numerals refer to like components.

The first meshing element 2 includes three prisms 4. The prisms are solid and formed from any preferred material, however, they can hollow or other preferred construction. Each prism 4 includes a prism body 80 with a hinge arm 81 extending a predetermined distance therefrom. Each prism 4 also has a hinge 82 spaced apart from the hinge arm 81. Each hinge arm 82 is configured for releasable engagement with a hinge 82 of an adjacent prism 4 of the first meshing element.

The three prisms 4 are configured to be disposed in a side-by-side arrangement. As best shown in FIG. 66, a hinge point 8 is provided about each hinge 82 which allows the rotation of a hinge arm 81 about a hinge 82. The hinge arms 81 are integrally formed with the prism bodies 80 and 90. The spaces between adjacent prisms 4 of the first meshing element 2 define three first meshing element engagement cavities 5.

The second meshing element 3 is substantially identical to the first meshing element 2. The element 3 also includes three trapezoidal prisms 10 configured to be disposed in a side-by-side arrangement. Each prism 10 includes a prism body 90 with a hinge arm 91 extending a predetermined distance therefrom. Each prism 10 also has a hinge 92 spaced apart from the hinge arm 91. Each hinge arm 91 is configured for releasable engagement with a hinge 92 of an adjacent prism 10 of the second meshing element 3.

The prisms 10 of the second meshing element 3 are configured to be retained in the first meshing element engagement cavities 5 by engagement of hinge 92 of one prism 10 with the hinge arm 91 of an adjacent prism 10. Likewise, the prisms 4 of the first meshing element 2 are configured to be retained in the second meshing element engagement cavities 11 by engagement of hinge 82 of one prism 4 with the hinge arm 81 of an adjacent prism.

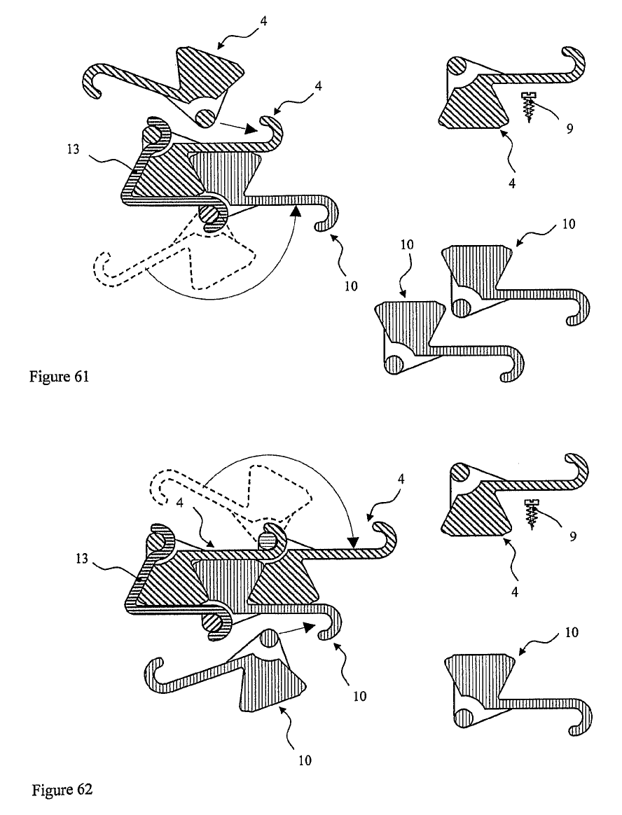

Referring particularly to FIGS. 59 to 66, there is shown the movement of the first and second meshing elements 2 and 3 so as to retainingly engage the prisms 4 and 10 with the cavities 11 and 5 respectively. FIG. 61, for example, shows an engagement cavity 11 of the second meshing element 3 receiving a prism 4 of the first meshing element 2.

It can be seen that a first prism 4 of the first meshing element 2 and a first prism 10 of the second meshing element 3 are configured to releasably engage with a locking plate 13. The locking plate 13 has a pair of outwardly extending arms 95 configured to engage with hinges 82 or 92 of the first prisms of the first and second meshing elements 2 and 3. It can be seen that the locking plate 13 is attached at one end to the hinge 82 of the received prism 4 and a hinge 92 an end prism 10 of the second meshing element 3 to restrain movement of the hinge 6 so as to retain the prisms 4 and 10 engaged with engagement cavities 11 and 5.

Each prism 10 is received in an engagement cavity 5 and likewise each prism 4 is received in an engagement cavity 11 and the hinge arms 81 and hinges 82 of adjacent prisms 4 releasably engage. As best seen in FIG. 66, a locking screw 9 is used to fix the hinge arm of the last prism 4 of the first meshing element 2 to the body of the prism 10 of the last prism of the second meshing element 3. This thereby locks all of the prisms 4 and 10 into respective engagement cavities 11 and 5, forming the structural member 1.

As similarly noted with reference to other preferred embodiments, any preferred locking means can be used to secure the prisms of the first and second meshing elements together.

In this embodiment, the prisms 4 and 10 and the engagement cavities 5 and 11 are of substantially the same shape. Thus, the structural member 1 shown in FIG. 11 is substantially planar. However, it will be appreciated that the first and second meshing elements 2 and 3 can be rolled up when disengaged from each other. Many variations to the preferred embodiment of the structural member 1 shown in FIGS. 58 to 66 can be made. For example, the prisms and engagement cavities, whether adjacent or not, can be any preferred shape. The prisms can be formed from a solid of a preferred material such as plastics, wood, metal, etc. The prisms can also be formed as an assembly of prism components provided in an unassembled form. Furthermore, the prisms can be formed from outer or skeletal frames which themselves may be collapsible. It is also noted the prisms can vary in cross-sectional shape along their length.

Of course, it will also be appreciated that the number of prisms 4 and 10 on each of the first and second meshing elements 2 and 3 can be any desired. Further, the number of prisms on the first meshing element 2, for example, can be one more than on the second meshing element 3.

The foregoing describes only preferred embodiment of the present invention and modifications, obvious to those skilled in the art, can be made thereto without departing from the scope of the present invention.

1. A structural member comprising:
a first meshing element having two prisms disposed in a side-by-side arrangement wherein a space between the two prisms defines a first meshing element engagement cavity, each prism in the first meshing element being connected to an adjacent prism via an arm of a hinge disposed intermediate the prisms;
a second meshing element having two prisms disposed in a side-by-side arrangement wherein a space between the two prisms defines a second meshing element being connected to an adjacent prism via an arm of a hinge disposed intermediate the prisms; and
a prism of the second meshing element is configured to be retained in a first meshing element engagement cavity and a prism of the first meshing element is configured to be retained in a second meshing element engagement cavity such that the first and second meshing elements are movable into locking engagement and each meshing element extends substantially parallel to the other.

2. A structural member according to claim 1 wherein the first meshing element includes at least three prisms in a side-by-side arrangement providing at least two first meshing element engagement cavities and the second meshing element includes at least two prisms providing at least one second meshing element engagement cavity, each prism of the second meshing element configured for locking engagement in adjacent first meshing element engagement cavities.

3. A structural member according to claim 1 wherein the prisms in the first and second meshing elements are connected to an adjacent prism by a pair of spaced apart hinges.

4. A structural member according to claim 2 wherein the prisms of the first and second meshing elements have substantially the same shape and when the first and second meshing elements are moved into locking engagement the structural member is substantially planar.

5. A structural member according to claim 2 wherein the prisms of the first meshing element are of a different shape than the prisms of the second element and when the first and second elements are locked together the structural member is contoured.

6. A structural member according to claim 2 wherein two or more prisms of the first meshing element are of a different shape to each other and two or more of the prisms of the second meshing element are of a different shape to each other and when the first and second elements are moved into locking engagement the structural member is not substantially planar.

7. A structural member according to claim 1 wherein each arm of each hinge is integral with a prism.

8. A structural member according to claim 1 wherein hinges are formed from a resilient strip-like material that is movable in a direction perpendicular to a longitudinal axis of the strip.

9. A structural member according to claim 1 wherein ends of the first and second meshing elements are configured to be locked together.

10. A structural member according to claim 1 wherein the prisms are periodically spaced along the first and second meshing elements.

11. A structural member according to claim 1 wherein hinges in the first and second meshing elements are disposed along a centerline between the prisms of the elements.

12. A structural member according to claim 1 wherein each prism is hollow and formed from an assembly of prism components.

13. A structural member according to claim 1 wherein the first and second meshing elements are designed to be rolled up when disengaged from each other.

14. A structural member according to claim 1 wherein the first and second meshing elements include a plurality of prisms and ends of the first and second meshing elements are connected together to form a closed loop.

15. A structural member according to claim 14 wherein the second meshing element include a plurality of discrete prisms.

16. A structural member according to claim 1 wherein the first and/or second meshing elements include at least two types of hinges interconnecting spaced apart prisms.

17. A structural member according to claim 1 wherein the first and/or second meshing elements include at least three hinges not equi-spaced between prisms.

18. A structural member according to claim 1 wherein the prisms have a non-constant cross-section.

19. A structural member comprising:
a first meshing element composed of at least one sheet of material selected from the group consisting of fibreboard, plastics material, and sheet metal, the first meshing element being folded to form at least two prisms disposed in a side-by-side arrangement, a space between the prisms defines a first meshing element engagement cavity, each prism in the first meshing element being connected to an adjacent prism;
a second meshing element composed of at least one sheet of fibreboard, the second meshing element being folded to form at least two prisms disposed in a side-by-side arrangement wherein a space between the prisms defines a second meshing element engagement cavity, each prism in the second meshing element being connected to an adjacent prism; and
a prism of the second meshing element is designed to be lockingly engaged in a first meshing element engagement cavity and a prism of the first meshing element is designed to be retained in a second meshing element engagement cavity such that the first and second meshing elements are movable into locking engagement and each meshing elements extends substantially parallel to the other.

20. A structural article according to claim 19 wherein the prisms of the first and second elements are connected via a connection selected from the group consisting of folds, welds, adhesive and connection means.

21. A structural article including the structural member according to claim 19 wherein the at least one sheet defining the first and second meshing elements includes at least one flap and one slot, the slot of the second element configured to be moved into locking engagement with the flap of the first element and the slot of the first element configured to be moved into locking engagement with the flap of the second element.

22. A structural article according to claim 19 being a box when the first and second meshing elements are moved into locking engagement and the flaps and slots are interengaged.

23. A structural member formed from a plurality of components and including:
a first meshing element having two prisms disposed in a side-by-side arrangement, a space between the prisms defines a first meshing element engagement cavity, each prism in the first meshing element being connected to an adjacent prism via an arm of a hinge disposed intermediate the prisms,
a second meshing element having two prisms each configured for engagement with at least one first meshing element engagement cavity; and
a prism of the second meshing element is configured to be retained in a first meshing element engagement cavity such that the first and second meshing elements are movable into locking engagement and each meshing element extends substantially parallel to the other.

24. A structural member according to claim 23 wherein the first meshing element includes at least three prisms in a side-by-side arrangement providing at least two first meshing element engagement cavities and the second meshing element includes at least two prisms, each prism of the second meshing element configured for locking engagement in adjacent first meshing element engagement cavities.

25. A structural member according to claim 24 wherein the plurality of second meshing element prisms are connected to an adjacent prism via an arm of a hinge disposed intermediate the prisms.

26. A structural member according to claim 23 wherein ends of the first meshing element are configured to be locked together.

27. A structural member according to claim 23 wherein the first meshing element is designed to be rolled up when disengaged from the second meshing element.

28. A structural member including:
a first meshing element having two prisms designed to be disposed in a side-by-side arrangement wherein a space between the prisms defines a first meshing element engagement cavity, each prism having a prism body with a hinge arm extending a predetermined distance therefrom, each prism body having a hinge spaced apart from the hinge arm, each hinge arm configured for releasable engagement with an adjacent prism of the first meshing element;
a second meshing element having two prisms designed to be disposed in a side-by-side arrangement, wherein a space between the prisms defines a second meshing element engagement cavity, each prism having a prism body with a hinge arm extending a predetermined distance therefrom, each prism body having a hinge spaced apart from the hinge arm, each hinge arm configured for releasable engagement with an adjacent prism of the second meshing element; and
a prism of the second meshing element is designed to be retained in a first meshing element engagement cavity and a prism of the first meshing element is designed to be retained in a second meshing element engagement cavity such that the first and second meshing elements are movable into locking engagement and each meshing element extends a substantially parallel to each other.

29. A structural member according to claim 28 wherein each first meshing element prism hinge arm is configured to engage with a hinge of an adjacent first meshing element prism, and each second meshing element prism hinge arm is configured to engage with the hinge of an adjacent second meshing element prism.

30. A structural member according to claim 28 wherein a first prism of the first meshing element and a first prism of the second meshing element are configured to releasably engage with a locking plate having a pair of outwardly extending arms configured to engage with hinges of the first prisms of the first and second meshing elements.

31. A structural member according to claim 28 wherein the first meshing element includes at least three prisms in a side-by-side arrangement providing at least two first meshing element engagement cavities and the second meshing element includes at least two prisms providing at least one second meshing element engagement cavity, each prism of the second meshing element configured for locking engagement in adjacent first meshing element engagement cavities.

32. A structural member according to claim 1 wherein each arm of each hinge is fixedly attached thereto.
